(19) United States
(12) Patent Application Publication
(10) Pub. No.: US 2024/0146939 A1
(43) Pub. Date: May 2, 2024

(54) DERIVATION OF RESAMPLING FILTERS FOR SCALABLE VIDEO CODING

(71) Applicant: ARRIS Enterprises LLC, Suwanee, GA (US)

(72) Inventors: David M. Baylon, San Diego, CA (US); Ajay K. Luthra, San Diego, CA (US); Koohyar Minoo, San Diego, CA (US)

(73) Assignee: ARRIS Enterprises LLC, Suwanee, GA (US)

(21) Appl. No.: 18/243,044

(22) Filed: Sep. 6, 2023

Related U.S. Application Data
(63) Continuation of application No. 14/247,560, filed on Apr. 8, 2014, now abandoned.
(60) Provisional application No. 61/809,816, filed on Apr. 8, 2013.

(51) Int. Cl. H04N 19/172; H04N 19/117; H04N 19/154; H04N 19/33; H04N 19/80

(52) U.S. Cl. CPC H04N 19/172; H04N 19/117; H04N 19/154; H04N 19/33; H04N 19/80; H04N 19/463

(57) ABSTRACT

A method for determining a resampling filter for resampling a video signal used in scalable video coding includes estimating a set of row filters based on a video signal. The video signal has a base resolution that is resampled to provide an output signal that enables more efficient coding of the video signal with an enhanced resolution higher than a base resolution. The set of row filters is applied to the video signal to generate a first output signal having rows that are interpolated to the enhanced resolution. A set of column filters is estimated based on the first output signal for resampling the columns in the video signal. The set of column filters is applied to the first output signal to generate a second output signal having columns as well as rows that are interpolated to the enhanced resolution.

### CROSS REFERENCE TO RELATED APPLICATION

This application claims priority under 35 U.S.C. § 119(e) from earlier filed U.S. Provisional Application Ser. No. 61/809,816 and incorporated herein by reference in its entirety.

### TECHNICAL FIELD

The present invention relates to a sampling filter process for scalable video coding. More specifically, the present invention relates to re-sampling using video data obtained from an encoder or decoder process, where the encoder or decoder process can be MPEG-4 Advanced Video Coding (AVC) or High Efficiency Video Coding (HEVC).

### BACKGROUND

Scalable video coding (SVC) refers to video coding in which a base layer, sometimes referred to as a reference layer, and one or more scalable enhancement layers are used. For SVC, the base layer can carry video data with a base level of quality. The one or more enhancement layers can carry additional video data to support higher spatial, temporal, and/or signal-to-noise SNR levels. Enhancement layers may be defined relative to a previously encoded layer.

The base layer and enhancement layers can have different resolutions. Upsampling filtering, sometimes referred to as resampling filtering, may be applied to the base layer in order to match a spatial aspect ratio or resolution of an enhancement layer. This process may be called spatial scalability. An upsampling filter set can be applied to the base layer, and one filter can be chosen from the set based on a phase (sometimes referred to as a fractional pixel shift). The phase may be calculated based on the spatial aspect ratio between base layer and enhancement layer picture resolutions.

To simplify the upsampling process, separate row and column upsampling filters are often employed to upsample the rows of video data separately from the columns of video data. However, in many cases the same filter is used to upsample both the rows and columns. Such systems may suffer from a lack of flexibility when upsampling a base layer to match a spatial aspect ratio or resolution of an enhancement layer.

### SUMMARY

Embodiments of the present invention provide methods, devices and systems for deriving resampling (e.g., upsampling, downsampling) filters for use in scalable video coding. The filters include separate row and column filters to enable parallel filter processing of samples along an entire row or column.

In accordance with one embodiment of the invention, a method and apparatus is provided for determining a resampling filter for resampling a video signal used in scalable video coding. In accordance with the method, a set of row filters is estimated based on a video signal. The video signal has a base resolution that is resampled to provide an output signal that enables more efficient coding of the video signal with an enhanced resolution higher than a base resolution. The set of row filters is applied to the video signal to generate a first output signal having rows that are interpolated to the enhanced resolution. A set of column filters is estimated based on the first output signal for resampling the columns in the video signal. The set of column filters is applied to the first output signal to generate a second output signal having columns as well as rows that are interpolated to the enhanced resolution. While in the above embodiment the row filters are estimated before the column filters, in other embodiments the column filters may be estimated before the row filters.

### BRIEF DESCRIPTION OF THE DRAWINGS

Further details of the present invention are explained with the help of the attached drawings in which:

FIG. 1 is a block diagram of components in a scalable video coding system with two layers;

FIG. 2 illustrates an upsampling process that can be used to convert the base layer data to the full resolution layer data for FIG. 1;

FIG. 3 shows a block diagram of components for implementing the upsampling process of FIG. 2;

FIG. 4 shows components of the select filter module and the filters, where the filters are selected from fixed or adaptive filters to apply a desired phase shift;

FIG. 5 illustrates an example of input samples x[m] provided to the upsampling system of FIG. 4;

FIG. 6 illustrates outputs y′[n] created from the samples x[m] of FIG. 5 using the upsampling system of FIG. 4 when the BL video is downsampled by removing every other element from the full resolution (FR) video;

FIG. 7 illustrates both rows and columns of input samples x[m] from FIG. 5 when the BL picture is 1080p;

FIG. 8 illustrates both row and column outputs y′[n] when the 1080p picture of FIG. 7 is upsampled to reproduce every other element to create a FR 4K video;

FIG. 9 shows one particular implementation of the resampling process shown in FIG. 3, which may be performed in a decoder or encoder;

FIG. 10 shows a process for estimating row and column resampling filters;

FIGS. 11-12 alternative embodiments of a process for estimating row and column resampling filters; and

FIG. 13 is a simplified block diagram that illustrates an example video coding system.

### DETAILED DESCRIPTION

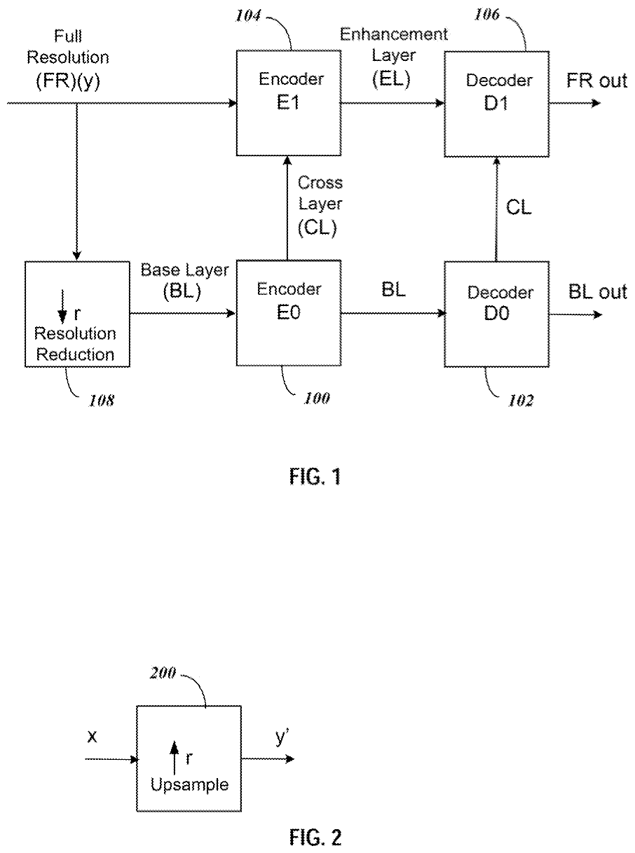

An example of a scalable video coding system using two layers is shown in FIG. 1. In the system of FIG. 1, one of the two layers is the Base Layer (BL) where a BL video is encoded in an Encoder E0, labeled 100, and decoded in a decoder D0, labeled 102, to produce a base layer video output BL out. The BL video is typically at a lower quality than the remaining layers, such as the Full Resolution (FR) layer that receives an input FR (y). The FR layer includes an encoder E1, labeled 104, and a decoder D1, labeled 106. In encoding in encoder E1 104 of the full resolution video, cross-layer (CL) information from the BL encoder 100 is used to produce enhancement layer (EL) information. The corresponding EL bitstream of the full resolution layer is then decoded in decoder D1 106 using the CL information from decoder DO 102 of the BL to output full resolution video, FR out. By using CL information in a scalable video coding system, the encoded information can be transmitted more efficiently in the EL than if the FR was encoded independently without the CL information. An example of coding that can use two layers shown in FIG. 1 includes video coding using AVC and the Scalable Video Coding (SVC) extension of AVC, respectively. Another example that can use two layer coding is HEVC.

FIG. 1 further shows block 108 with a down-arrow r illustrating a resolution reduction from the FR to the BL to illustrate that the BL can be created by a downsampling of the FR layer data. Although a downsampling is shown by the arrow r of block 108 FIG. 1, the BL can be independently created without the downsampling process. Overall, the down arrow of block 108 illustrates that in spatial scalability, the base layer BL is typically at a lower spatial resolution than the full resolution FR layer. For example, when r=2 and the FR resolution is 3840×2160, the corresponding BL resolution is 1920×1080.

The cross-layer CL information provided from the BL to the FR layer shown in FIG. 1 illustrates that the CL information can be used in the coding of the FR video in the EL. In one example, the CL information includes pixel information derived from the encoding and decoding process of the BL. Examples of BL encoding and decoding are AVC and HEVC. Because the BL pictures are at a different spatial resolution than the FR pictures, a BL picture needs to be upsampled (or re-sampled) back to the FR picture resolution in order to generate a suitable prediction for the FR picture.

FIG. 2 illustrates an upsampling process in block 200 of data from the BL layer to the EL. The components of the upsampling block 200 can be included in either or both of the encoder E1 104 and the decoder D1 106 of the EL of the video coding system of FIG. 1. The BL data at resolution x that is input into upsampling block 200 in FIG. 2 is derived from one or more of the encoding and decoding processes of the BL. A BL picture is upsampled using the up-arrow r process of block 200 to generate the EL resolution output y′ that can be used as a basis for prediction of the original FR input y.

The upsampling block 200 works by interpolating from the BL data to recreate what is modified from the FR data. For instance, if every other pixel is dropped from the FR in block 108 to create the lower resolution BL data, the dropped pixels can be recreated using the upsampling block 200 by interpolation or other techniques to generate the EL resolution output y′ from upsampling block 200. The data y′ is then used to make encoding and decoding of the EL data more efficient.

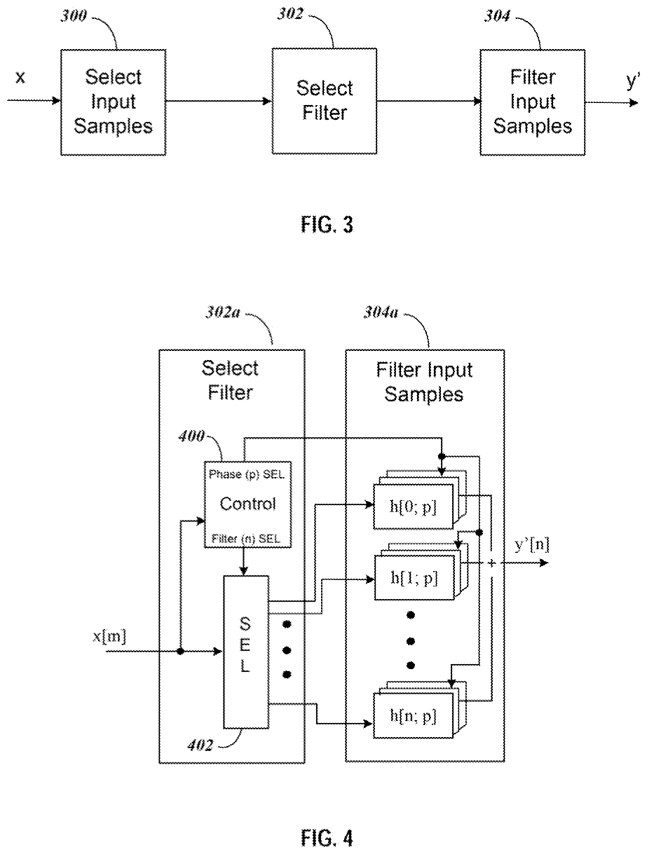

FIG. 3 shows a general block diagram for implementing an upsampling process of FIG. 2 for embodiments of the present invention. The upsampling or re-sampling process can be determined to minimize an error E (e.g. mean-squared error) between the upsampled data y′ and the full resolution data y. The system of FIG. 3 includes a select input samples module 300 that samples an input video signal. The system further includes a select filter module 302 to select a filter from the subsequent filter input samples module 304 to upsample the selected input samples from module 300.

In module 300, a set of input samples in a video signal x is first selected. In general, the samples can be a two-dimensional subset of samples in x, and a two-dimensional filter can be applied to the samples. The module 302 receives the data samples in x from module 300 and identifies the position of each sample from the data it receives, enabling module 302 to select an appropriate filter to direct the samples toward a subsequent filter module 304. The filter in module 304 is selected to filter the input samples, where the selected filter is chosen or configured to have a phase corresponding to the particular output sample location desired.

The filter input samples module 304 can include separate row and column filters. The selection of filters is represented herein by the P as filters h[n; p], where p is a phase index that runs from 0 to (P−1). That is, if, for instance, P=10, then there are a family of 10 filters h[n; 0], h[n; 1] . . . h[n; 9]. Each filter can have N+1 coefficients e.g., a filter with phase index p=3 has the coefficients h[0; 3], h[1; 3] . . . h[N; 3]. As used herein a family of P filters will be denoted as h[n,p], whereas a particular filter having a selected phase will be denoted as h[n], where the filter has N+1 coefficients. The output of the filtering process using the selected filter h[n] on the selected input samples produces output value y′.

FIG. 4 shows details of components for the select sample module 302 of FIG. 3 (labeled 302a in FIG. 4) and the filters module 304 of FIG. 3 (labeled 304a in FIG. 4) for a system with fixed filters. For separable filtering the input samples can be along a row or column of data. To supply a set of input samples from select input samples module 300, the select filter module 302a includes a select control 400 that identifies the input samples x[m] and provides a signal to a selector 402 that directs them through the selector 402 to a desired filter. The filter module 304a then includes the different filters h[n;p] that can be applied to the input samples, where the filter phase can be chosen among P phases from each row or column element depending on the output sample m desired. As shown, the selector 402 of module 302a directs the input samples to a desired column or row filter in 304a based on the “Filter (n) SEL” signal from select control 400. A separate select control 400 signal “Phase (p) SEL” selects the appropriate filter phase p for each of the row or column elements. The filter module 304a output produces the output y′[n].

In FIG. 4, the outputs from individual filter components of h[n;p] are shown being added “+” to produce the output y′[n]. This illustrates that each box, e.g. h[0;p], represents one coefficient or number in a filter with phase index p. Therefore, the filter represented by a phase index p includes all N+1 coefficients in h[0,p], . . . , h[N;p]. This is the filter that is applied to the selected input samples to produce an output value y′[n], for example, y′[0]=h[0,p]*x[0]+h[1,p]*x[1]+ . . . +h[N,p]*x[N], requiring the addition function “+” as illustrated. As an alternative to adding in FIG. 4, the “+” could be replaced with a solid connection and the output y′[n] would be selected from one output of a bank of P filters representing the P phases, with the boxes h[n:p] in module 304a relabeled, for example, as h[n;0], h[n,1], . . . , h[n,P−1] and now each box would have all the filter coefficients needed to form y′[n] without the addition element required.

Although the filters h[n:p] in module 304a are shown as having fixed phases, they can be implemented using a single filter with the phase being selected and adaptively controlled. The adaptive phase filters can be reconfigured, for example, by software. The adaptive filters can thus be designed so that each filter h[n] corresponds to a desired phase. The filter coefficients h[n] for a given filter can be signaled in the EL from the encoder so that the decoder can reconstruct a prediction to the FR data.

Phase selection for the filters h[n:p] enables recreation of the FR layer from the BL data. For example, if the BL data is created by removing every other pixel of data from the FR, to recreate the FR data from the BL data, the removed data must be reproduced or interpolated from the BL data available. In this case, depending on whether even or odd indexed samples are removed, the appropriate filter h[n;p] with a phase represented by a phase index p can be used to interpolate the new data. The selection of P different phase filters from the filters h[n:p] allows the appropriate phase shift to be chosen to recreate the missing data depending on how the BL data is downsampled from the FR data.

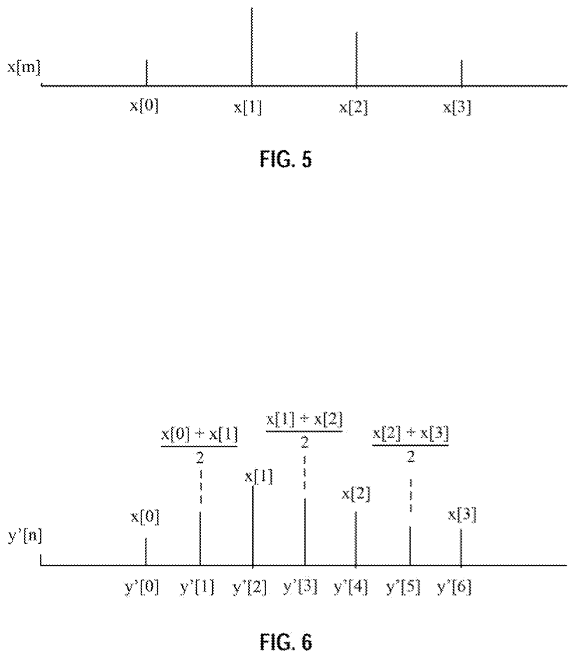

FIGS. 5-6 illustrate use of the system of the upsampling system of FIG. 4 where either even or odd samples are removed to create the BL data from the FR data. FIG. 5 illustrates samples x[m] including input samples x[0] through x[3] which are created by removing either even or odd samples from FR data. The system of FIG. 4 will use the select filter 302a control 400 to direct the samples x[m] of FIG. 5 to individual filters 304a of a row or column, and further control 400 will select the phase p of filters 304a to provide output y′[n] as illustrated in FIG. 6. As shown in FIG. 6, the sample x[0] will be provided as y′[0] and sample x[1] will be y′[2]. In one example, averaging can be performed to recreate the data element y′[1] as the average of y′[0] and y′[2] which are its two adjacent data points to yield (x[0]+x[1])/2. The next data element after y′[2], which is element y′[3], will be recreated as the average of its adjacent data points y′[2] and y′[4], or (x[1]+x[2])/2, and so forth.

Note that when the output y′[n] provides the same number of samples as the input x[m] then no samples will have been dropped from the FR layer to form the BL layer, and the BL data will be the same resolution as the FR layer. In the examples of FIGS. 5-6, since ½ of the total samples is dropped, y′[n] will provide twice the number of samples compared to x[m] from the BL.

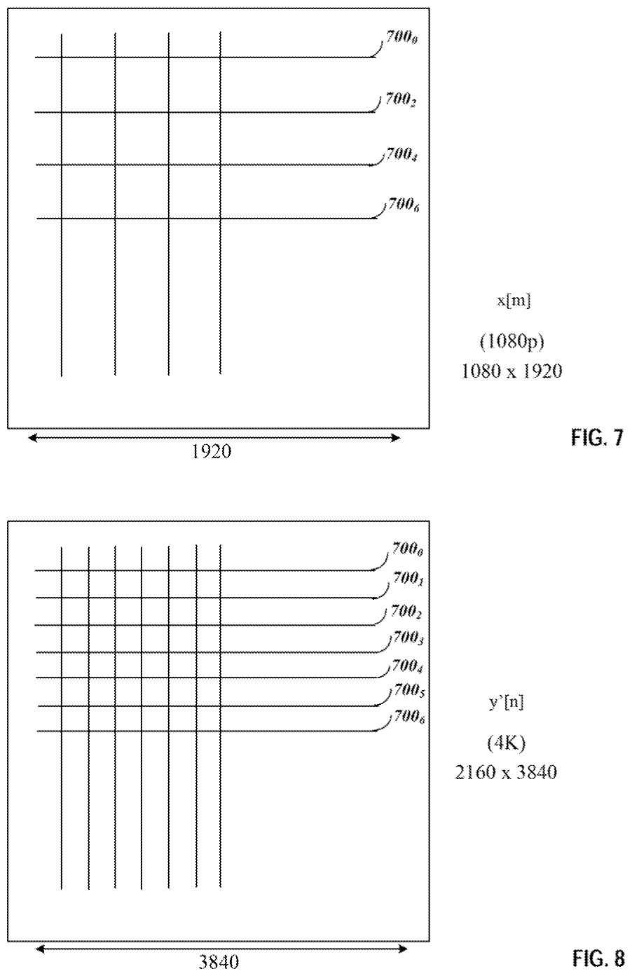

FIGS. 7-8 illustrate how continuing to perform the data upsampling from FIG. 5 to FIG. 6 for additional rows or columns will enable recreation of an entire picture. Assuming that FIGS. 5-6 illustrate upsampling for a row, FIGS. 7-8 expand the example to multiple rows and columns. Assuming FIG. 5 shows one row x[0]−x[3], that row can be comparable to row 700₀ in FIG. 7. Additional rows and columns of samples x[m] can be processed from the entire BL data picture of FIG. 7, such as row 700₂, 700₄ and 700₆. FIG. 7 is shown to illustrate 1080p which has a picture size of 1080×1920 pixels. FIG. 8 is 2× the size of 1080p or a 4K picture which has dimensions 2160×3840. Thus the 1080p picture of FIG. 7 can be the downsampled version with odd or even samples removed from a 4K picture. Thus, by interpolating the data x[m] of FIG. 7 to reproduce removed odd or even samples in an upsampling system as shown in FIG. 4, FIG. 8 will be created as output data y′[n]. The y′[n] data of FIG. 8 will then be the upsampled version of FIG. 7 and will illustrate all columns and rows of a picture being upsampled, as opposed to a single column or row of FIG. 6. The illustration of FIG. 8 shows production of all rows 700₀-700₆ to fill in the odd rows from FIG. 7.

Although the simple averaging of data for interpolation is shown in FIG. 6, such as data point y′[1]=(x[0]+x[1])/2, as described above, more complicated formulas can be used to determine dropped data. To provide these more complex formulas, the phase in the filters h[n;p] can be adaptable to provide complex values rather than simple fixed values. Such adaptable phase values can be varied in software. For the adaptable or variable filters, the filter coefficients h[n] can be signaled in the EL so that the encoder 104 of FIG. 1 can reconstruct a prediction to the FR data. However, if an adaptable phase value is used in the EL encoder 104, then the filter coefficients in some cases will need to be transmitted to the EL decoder 106 to enable encoding and decoding using the same phase offset for each sample. With fixed filters and data provided that will be reproduced with a predictable phase offset, the filter coefficients would not be necessary to transmit from the encoder 104 to the decoder 106.

For more specific or complex phase shift selection, the module 304a of FIG. 4 can be implemented with a set of M filters h[n, p], p=0, 1, 2, . . . M−1, where for the output value y[n] at output time index m, the filter h[n; m mod M] is chosen and is applied to the corresponding input samples x. The filters h[n; p] where p=m mod M generally correspond to filters with M different phase offsets, for example with phase offsets of p/M, where p=0, 1, . . . , M−1.

Selection criteria for determining a filter phase are applied by the select control 400 of the select filter module 302a in FIG. 4. The optimal filter phase p to choose for output index m can depend on how the lower resolution BL x[n] was generated, as described above. For example, assume that M=8. In the case of downsampling by a factor of 2 from FR to BL, if the BL samples were generated using a zero phase filter (or a set of filters with zero phase), then the corresponding filters h[n, p] for upsampling by a factor of 2 can be selected to correspond to output filter phases of p=0 (0), 4 ( 4/8) when M=8. On the other hand, if the BL samples where generated with a non-zero phase shift q (such as when preserving 420 color space sampling positions in the BL), for example q=¼, then the corresponding filters for upsampling by 2 can be selected to correspond to different output filter phases, for example p=7 (−⅛), 3 (⅜).

For the upsampling process components for FIG. 4, embodiments of the present invention contemplate that the components can be formed using specific hardware components as well as software modules. For the software modules, the system can be composed of one or more processors with memory storing code that is executable by the processor to form the components identified and to cause the processor to perform the functions described. More specifics of filter designs that can be used with the components of FIG. 4 are described in the following sections.

As described previously, any phase offset applied in generating the downsampled BL data from the FR data should be accounted for in the corresponding upsampling process in order to improve the performance of the FR prediction. One way to achieve this is by specifying the appropriate phases of the filters 304 used for the re-sampling processes. As indicated above, the filters 304 can be configured as adaptive as illustrated in FIG. 4 to enable more precise phase control to improve predicted data in the upsampling process.

In the absence of knowing any information about the appropriate phase, the filters 304 can be designed or derived based on only the BL and FR data. That is, given the BL pixel data, the filters are derived, for example, to minimize an error between the upsampled BL pixel data and the original FR input pixel data. Minimum mean squared error techniques can be used to solve for the filter coefficients such as Wiener filtering methods and matrix inversion techniques, where auto-correlation and cross-correlation is computed based on the BL and FR data. Note that the designed filters are upsampling filters as opposed to filters which are designed after the BL has been upsampled, e.g. by using some filters with fixed filtering coefficients. The filter(s) can be derived based on current or previously decoded data. In minimizing the error between the upsampled BL and FR, the designed filter(s) will implicitly have the appropriate phase offset(s).

The specified or derived filter coefficients used in the upsampling of FIG. 4 can be transmitted in the EL, or a difference between the coefficients and a specified (or predicted) set of coefficients can be transmitted to enable filter selection. With adaptive phase shift filtering in FIG. 4, the set of phases for which the p filters h[n;p] represent need not be uniformly spaced. The coefficient transmission can be made at some unit level (e.g. sequence parameter set (SPS), picture parameter set (PPS), slice, largest coding unit (LCU), coding unit (CU), prediction unit (PU), etc.) and per color component. Furthermore several sets of filters can be signaled per sequence, picture or slice and the selection of which set to be used for re-sampling can be signaled at finer levels, for example at picture, slice, LCU, CU or PU level.

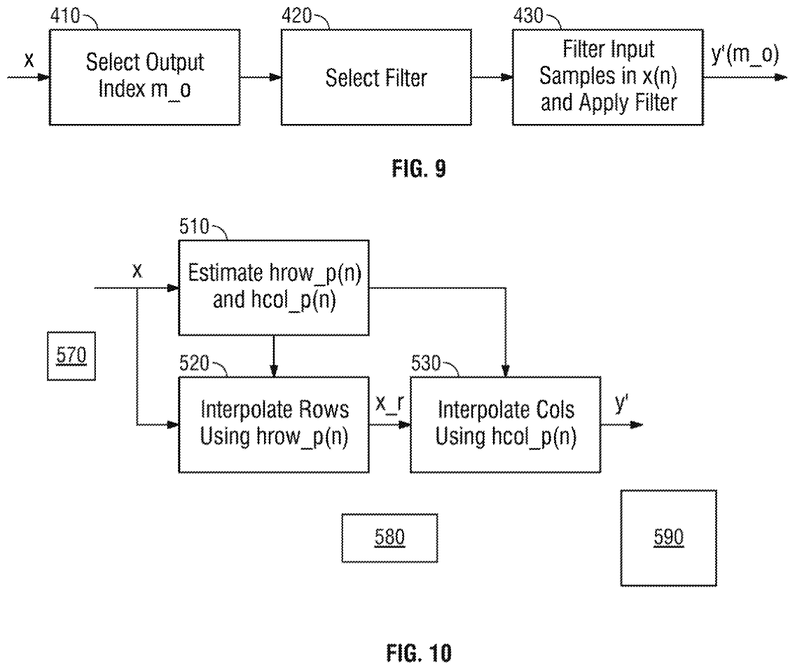

FIG. 9 shows one particular implementation of the resampling process shown in FIG. 3, which may be performed in a decoder or encoder. This process may be applied to each color component in the video. For the purposes of the following discussion the set of P filters, which had previously been denoted as h[n, p] will now be denoted as the set of filters hp(n). As will be seen below, this change of notation better distinguishes between a one-dimensional resampling filter such as hp(n) and a two-dimensional resampling filter hp(n1, n2)

Referring now to FIG. 9, for a selected output point y′(m) in the full resolution video data y with output index m=m_o, a filter hp(n) is selected. This filter hp(n) is then applied to the selected input samples in x(n) to determine the output value y′(m), where m=m_o. The selected input samples can be determined based on the index m_o and filter h_i(n), and the filtering operation may consist of an inner product operation between the input samples and the filter coefficients. That is, the input samples x(n), and the appropriate filter hp(n), are chosen based on the selected output value y′(m) that is to be calculated.

Accordingly, in FIG. 9 the process begins at block 410 where the output index m_O is first selected. Next, at block 420 the appropriate resampling filter is selected and at block 430 the resampling filter is applied to the input sample x(n) to determine the output sample y′(m_o).

Although the process of FIG. 9 has been described in terms of a one-dimensional process, the extension to multiple dimensions is straightforward. For example, in two-dimensions, an output point y(m1_o, m2_o) can be selected, and a filter hp(n1, n2) chosen. The filter is then applied to the selected input samples x(n1, n2) to determine the output value y(m1_o, m2_o). For two-dimensional filters, the filter may be non-separable or separable; in the separable case, the filters can be implemented as two one-dimensional filters.

In one embodiment, the set of filters hp(n) depends on the characteristics of the data, for example, the BL and FR data as described above. In another embodiment, the number of filters in the set can be determined based on the re-sampling ratio, such as determined by the input and output resolutions. For example, in upsampling by a factor of 2, the set may consist of two filters, one with a zero phase offset and another with ½ phase offset. In selecting the filters for output computation, the filter selection may alternate between the two filters (and phases). More generally, there can be many filters, each with their own phase and amplitude characteristics, and the assignment of a filter from the set to the output index can be either specified or follow a predetermined pattern.

By allowing the filter set hp(n) to be selected based upon the data, better MSE performance can be achieved between the upsampled BL and the FR data than can be achieved with a fixed set of filters. In addition, it can better compensate for any phase offset that may have been introduced in the downsampling process. In the example of upsampling by a factor of 2, the two filters can have phase offsets of 0+α and ½+β for some selected values of α and β. Note that although the re-sampling ratio may specify a certain number of filters, an encoder may specify a different number of filters.

In another embodiment, the set of filters may include different filters with the same phase offset. In this case, the filters may differ in amplitude response or the number of taps and the particular one to use for a given phase offset or output position can be signaled or inferred. For example, if there is more than one filter in the set with the same phase offset, an index corresponding to the filter to be used can be specified at a CU level, a LCU level, a slice level, etc.

The number of filters and filter coefficients can be transmitted in the EL, or a difference between the coefficients and a specified (or predicted) set of coefficients can be transmitted. The coefficient transmission can be made at some unit level (e.g. SPS, PPS, slice, LCU, CU, PU, etc.) and per color component. Furthermore several sets of filters can be signaled per sequence, picture or slice and the selection of which set to be used for re-sampling can be signaled at finer levels, for example at the picture, slice, LCU, CU or PU level.

### Separable Column and Row Filtering

As previously mentioned, the resampling filters can be one-dimensional or two-dimensional filters. Generally, a one-dimensional filter is separately applied to the rows and columns of the video signal and, although the same filter is generally used for the columns and for the rows. For the re-sampling process, in one embodiment the filters applied can be separable, and the coefficients for each horizontal (row) and vertical (column) dimension can be signaled or selected from a set of filters. The processing of row or columns separably allows for flexibility in filter characteristics (e.g. phase offset, frequency response, number of taps, etc.) in both dimensions while retaining the computational benefits of separable filtering. In addition, however, it may be advantageous to employ different filters for the rows and columns since the characteristics of the data may differ along the rows relative to the columns.

FIG. 10 shows a process for estimating row and column resampling filters. In this example the input x represents the BL data. The set of row filters hrow_p(n) and the set of column filters hcol_p(n) are each estimated at block 510. In one embodiment, the row (or column) filters can be determined to minimize an MSE between an upsampled version of x and a targeted output. One example of the targeted output is the FR data y. At block 520 the set of row filters is applied to x to generate an output x_r. That is, the row filters are used to interpolate the rows of the input x. Accordingly, if as shown in FIG. 10 the input x represents a square video picture 570 the output x_r will be the rectangular video picture 580. Next, at block 530, the set of column filters hcol_p(n) is applied to x_r to generate the interpolated output y′, which is represented by the square video picture 590. It should be noted that for an upsampling process the square output video picture 590 will be larger than the square input video picture 570. In one embodiment, each of the row and column resampling processes can be performed as described above in connection with FIG. 9.

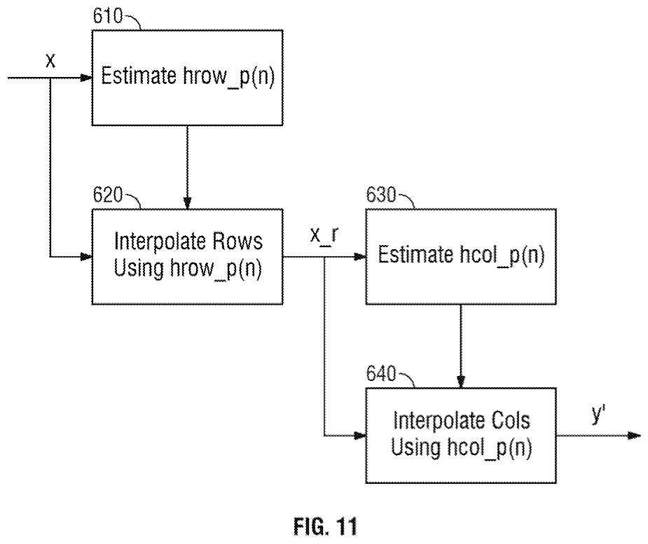

FIG. 11 shows another embodiment of a process for estimating row and column resampling filters. In this embodiment the resampling row filters are first estimated and applied to the input x to generate an output x_r. The resampling column filters are then estimated using the output data x_r. Accordingly, the estimate for resampling column filters may be improved over the estimate in the process of FIG. 10 since it is based on the additional information gained from interpolating the rows using the estimated resampling row filters. Of course, in some embodiments the order of the process may be reversed so that the column resampling filters are estimated before the row resampling filters.

More specifically, in FIG. 11 the set of row filters hrow_p(n) is estimated at block 610. Next, at block 620 the set of row filters is applied to input x to generate an output x_r. That is, the row filters are used to interpolate the rows of the input x. The column filters hcol_p(n) are then estimated at block 630 using the data x_r as the input data. Finally, the estimated column filters hcol_p(n) are applied to the input data x_r to generate the interpolated output y′.

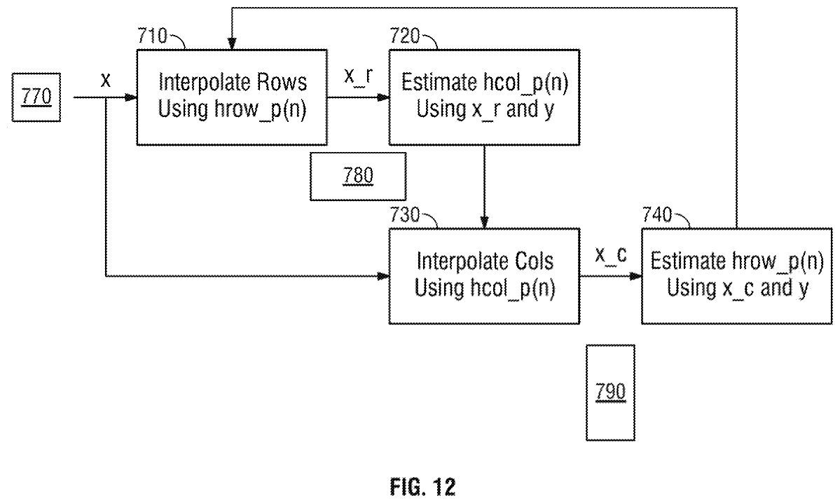

FIG. 12 shows yet another embodiment of a process for estimating row and column resampling filters. This process is similar to the process shown in FIG. 11 except that a feedback loop is employed to iterate the estimated values for the resampling row and column filters. At block 710, a set of resampling row filters hrow_p(n) is applied to the input x to generate x_r in which the rows are interpolated. Accordingly, if as shown in FIG. 12 the input x represents a square video picture 770 the output x_r will be the rectangular video picture 780. This first set of resampling row filters hrow_p(n) can be initialized using a default set of filters. In one embodiment, the generation of the output x_r from the input x at block 710 is performed using the process shown in FIG. 9.

Next, at block 720, a set of resampling column filters hcol_p(n) is estimated, for example, to minimize the MSE between the upsampled data x_r and y, where y is the FR data. The estimated filter hcol_p(n) is then used at block 730 to interpolate the columns of x to generate x_c., which is represented by rectangular video picture 790. At block 740 a set of resampling row filters hrow_p(n) is estimated, for example, to minimize the MSE between upsampled data x_c and y.

At this point, a set of column filters hcol_p(n) and row filters hrow_p(n) have been estimated and can be applied to the input data x to generate the output data y, such as by using row interpolation followed by column interpolation. This process can be repeated by applying the set of row filters hrow_p(n) from block 740 to interpolate the rows of the input data x to generate x_r at block 710. A new column filter set hcol_p(n) is then estimated based on x_r and y in the second pass through block 720 of the process. In the second pass through block 730, the newly generated hcol_p(n) is used to interpolate the columns of the input data x to generate x_c. In the second pass through block 740, a new set of row filters hrow_p(n) is estimated based on x_c and y. This process (or parts of the process) can be repeated a specified number of times, or can be stopped after the filter set generated for a given row and/or column does not change significantly from one pass to the next. Once the row and column filters have been determined, they can be applied to the input x to generate the output y. Similar to the process shown in FIG. 11, in some embodiments the order of the process in FIG. 12 may be reversed so that the column resampling filters are estimated before the row resampling filters.

It should be noted that although the processes shown in FIGS. 10-12 have been described generally in terms of resampling, they are applicable to both upsampling and downsampling as well as to any combination of upsampling and downsampling in the row or column directions. Moreover, the processes may also be employed even if the input and output resolutions are the same (no net upsampling or downsampling). In this case, the filtering can correspond to PSNR or quality scalability instead of spatial scalability. The process can be applied to each color component, and the order of row and column filtering can be specified.

The resampling filter estimation processes described above in connection with FIGS. 10-12 can be performed and applied using the BL data, which may or may not have undergone a deblocking process (such as used in AVC and HEVC) or a sample adaptive filter (SAO) process (such as used in HEVC). In one embodiment for an AVC and HEVC BL, signaling is provided to indicate whether the BL data for re-sampling is deblocked data or not. For an HEVC BL, if the data has been deblocked, signaling is further provided to indicate whether the BL data for re-sampling has been further processed with SAO or not. The signaling can be performed at some unit level (e.g. SPS, PPS, slice, LCU, CU, PU, etc.) and per color component, or it can be derived or predicted from other previously decoded data.

### Illustrative Operating Environment

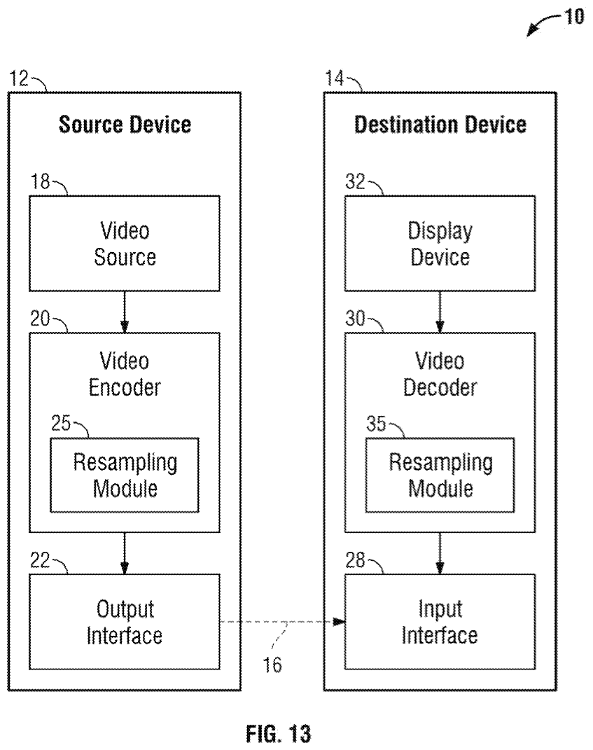

FIG. 13 is a simplified block diagram that illustrates an example video coding system 10 that may utilize the techniques of this disclosure. As used described herein, the term “video coder” can refer to either or both video encoders and video decoders. In this disclosure, the terms “video coding” or “coding” may refer to video encoding and video decoding.

As shown in FIG. 13, video coding system 10 includes a source device 12 and a destination device 14. Source device 12 generates encoded video data. Accordingly, source device 12 may be referred to as a video encoding device. Destination device 14 may decode the encoded video data generated by source device 12. Accordingly, destination device 14 may be referred to as a video decoding device. Source device 12 and destination device 14 may be examples of video coding devices.

Destination device 14 may receive encoded video data from source device 12 via a channel 16. Channel 16 may comprise a type of medium or device capable of moving the encoded video data from source device 12 to destination device 14. In one example, channel 16 may comprise a communication medium that enables source device 12 to transmit encoded video data directly to destination device 14 in real-time. In this example, source device 12 may modulate the encoded video data according to a communication standard, such as a wireless communication protocol, and may transmit the modulated video data to destination device 14. The communication medium may comprise a wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or other equipment that facilitates communication from source device 12 to destination device 14. In another example, channel 16 may correspond to a storage medium that stores the encoded video data generated by source device 12.

In the example of FIG. 13, source device 12 includes a video source 18, video encoder 20, and an output interface 22. In some cases, output interface 22 may include a modulator/demodulator (modem) and/or a transmitter. In source device 12, video source 18 may include a source such as a video capture device, e.g., a video camera, a video archive containing previously captured video data, a video feed interface to receive video data from a video content provider, and/or a computer graphics system for generating video data, or a combination of such sources.

Video encoder 20 may encode the captured, pre-captured, or computer-generated video data. The encoded video data may be transmitted directly to destination device 14 via output interface 22 of source device 12. The encoded video data may also be stored onto a storage medium or a file server for later access by destination device 14 for decoding and/or playback.

In the example of FIG. 13, destination device 14 includes an input interface 28, a video decoder 30, and a display device 32. In some cases, input interface 28 may include a receiver and/or a modem. Input interface 28 of destination device 14 receives encoded video data over channel 16. The encoded video data may include a variety of syntax elements generated by video encoder 20 that represent the video data. Such syntax elements may be included with the encoded video data transmitted on a communication medium, stored on a storage medium, or stored a file server.

Display device 32 may be integrated with or may be external to destination device 14. In some examples, destination device 14 may include an integrated display device and may also be configured to interface with an external display device. In other examples, destination device 14 may be a display device. In general, display device 32 displays the decoded video data to a user.

Video encoder 20 includes a resampling module 25 which may be configured to code (e.g., encode) video data in a scalable video coding scheme that defines at least one base layer and at least one enhancement layer. Resampling module 130 may resample at least some video data as part of an encoding process, wherein resampling may be performed in an adaptive manner using resampling filters developed in accordance with the techniques described above in connection with FIGS. 10-12, for example. Likewise, video decoder 30 may also include a resampling module 35 similar to the resampling module 25 employed in the video encoder 20.

Video encoder 20 and video decoder 30 may operate according to a video compression standard, such as the High Efficiency Video Coding (HEVC) standard. The HEVC standard is being developed by the Joint Collaborative Team on Video Coding (JCT-VC) of ITU-T Video Coding Experts Group (VCEG) and ISO/IEC Motion Picture Experts Group (MPEG). A recent draft of the HEVC standard, referred to as “HEVC Working Draft 7” or “WD 7,” is described in document JCTVC-11003, Bross et al., “High efficiency video coding (HEVC) Text Specification Draft 7,” Joint Collaborative Team on Video Coding (JCT-VC) of ITU-T SG16 WP3 and ISO/IEC JTC1/SC29/WG11, 9th Meeting: Geneva, Switzerland, Apr. 27, 2012 to May 7, 2012.

Additionally or alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard or technique. Other examples of video compression standards and techniques include MPEG-2, ITU-T H.263 and proprietary or open source compression formats and related formats.

Video encoder 20 and video decoder 30 may be implemented in hardware, software, firmware or any combination thereof. For example, the video encoder 20 and decoder 30 may employ one or more processors, digital signal processors (DSPs), application specific integrated circuits (ASICs), field programmable gate arrays (FPGAs), discrete logic, or any combinations thereof. When the video encoder 20 and decoder 30 are implemented partially in software, a device may store instructions for the software in a suitable, non-transitory computer-readable storage medium and may execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Also, it is noted that some embodiments have been described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Although the subject matter has been described in language specific to structural features and/or methodological acts, it is to be understood that the subject matter defined in the appended claims is not necessarily limited to the specific features or acts described above.

1-20. (canceled)

21. A resampling device for use in a video encoder that includes a processor, the video encoder comprising:
said encoder initializing a set of filters for a video signal, the video signal having a base resolution, where the base resolution is resampled to provide an output signal that enables coding of the video signal upon determination of an enhanced resolution, the set of filters including one of row or column filters for respectively resampling rows or columns in the video signal and the set of filters also including the other one of row or column filters for respectively resampling rows or columns in the video signal;
said encoder applying the set of filters to the video signal to generate an output signal having rows or columns that are interpolated to the enhanced resolution;
said encoder estimating the set of filters based on the output signal for resampling rows or columns in the video signal;
said encoder applying the estimated set of filters to the video signal to generate an output signal having columns or rows that are interpolated to the enhanced resolution;
wherein the estimating is repeated iteratively to modify said set of filters until a limit is met,
said encoder determining whether the base layer data for re-sampling is deblocked data that has reduced artifacts at block boundaries for enhancement layer High Efficiency Video Coding (HEVC) data that is signaled with a deblocking indication to a decoder,
said encoder determining when the data is deblocked, a determination of whether the base layer data for re-sampling has been further processed with a Sample Adaptive Offset (SAO) that is signaled with a SAO indication to the decoder.

22. The resampling device of claim 21 wherein the coefficients are transmitted at a unit level including at least one of sequence parameter set (SPS), picture parameter set (PPS), slice, largest coding unit (LCU), coding unit (CU), prediction unit (PU) and per color component.

23. The resampling device of claim 21 wherein estimating the set of filters further comprises determining the set of filters by minimizing a mean square error (MSE) between an upsampled version of the video signal and a target output.

24. The resampling device of claim 24 wherein the target output is the video signal with full resolution.

25. The resampling device of claim 21 further comprising transmitting a difference between coefficients of the filters and a specified set of coefficients from an encoder to a decoder.

26. The resampling device of claim 21 wherein the filters are selected per at least one of sequence, picture, slice, largest coding unit (LCU), coding unit (CU) and prediction unit (PU) levels.

27. A method for determining filter coefficients for video encoding comprising:
initializing a set of filters for a video signal, the video signal having a base resolution, where the base resolution is resampled to provide an output signal that enables coding of the video signal upon determination of an enhanced resolution, the set of filters including one of row or column filters for respectively resampling rows or columns in the video signal and the set of filters also including the other one of row or column filters for respectively resampling rows or columns in the video signal;
applying the set of filters to the video signal to generate an output signal having rows or columns that are interpolated to the enhanced resolution;
estimating the set of filters based on the output signal for resampling rows or columns in the video signal;
applying the estimated set of filters to the video signal to generate an output signal having columns or rows that are interpolated to the enhanced resolution,
wherein the estimating is repeated iteratively to modify said set of filters until a limit is met;
wherein the estimates includes
a determination of whether the base layer data for re-sampling is deblocked data that has reduced artifacts at block boundaries needed for enhancement layer High Efficiency Video Coding (HEVC) data that is signaled with a deblocking indication to a decoder.
